(19) United States
(12) Patent Application Publication
(10) Pub. No.: US 2021/0401253 A1
(43) Pub. Date: Dec. 30, 2021

(54) ELECTROSTATIC PROTECTION SYSTEM AND HAND-HELD VACUUM CLEANER USING THE SYSTEM

(71) Applicant: Kingclean Electric Co., LTD, Suzhou (CN)

(72) Inventor: Zugen NI, Suzhou (CN)

(21) Appl. No.: 16/476,446

(22) PCT Filed: Nov. 2, 2017
(86) PCT No.: PCT/CN2017/109027

§ 371 Date: Jul. 8, 2019

(30) Foreign Application Priority Data
Jan. 25, 2017 (CN) 201710060619.5

(51) Int. Cl. A47L 9/28; A47L 5/24; A47L 9/24; H05F 3/04

(52) U.S. Cl. CPC A47L 9/2889; A47L 5/24; H05F 3/04; A47L 9/248; A47L 9/2884

(57) ABSTRACT

An electrostatic protection system for hand-held wireless vacuum cleaner comprises an electrostatic collecting unit and an electrostatic dissipating unit. The electrostatic collecting unit comprises an electrostatic collecting device; the electrostatic dissipating unit comprises a battery pack assembly, and the electrostatic collecting device is electrically connected to a negative electrode of the battery pack assembly. The electrostatic collecting unit is electrically connected to the electrostatic dissipating unit, and an electrostatic charge is transmitted to the negative electrode of the battery pack assembly through the electrostatic collecting device to realize electrostatic charge transfer. The electrostatic protection system effectively transfers the accumulated electrostatic charge, thereby avoiding the phenomenon of electrostatic shock, e.g. on the human's hand, and also protecting important components inside a machine from electrostatic damage.

### CROSS-REFERENCE TO RELATED APPLICATIONS

This application is a US national application of International Application No. PCT/CN2017/109027 filed on Nov. 2, 2017, which claims the benefit of priority to Chinese Patent Application No. 201710060619.5 titled “ELECTROSTATIC PROTECTION SYSTEM AND HAND-HELD VACUUM CLEANER USING THE SYSTEM”, filed with the China State Intellectual Property Office on Jan. 25, 2017, the disclosures of which are hereby incorporated by reference in their entirety.

### TECHNICAL FIELD

The present invention relates to the field of vacuum cleaners, and more particularly to an electrostatic protection system and a hand-held vacuum cleaner using the same.

### BACKGROUND

Static electricity is a stationary or non-flowing electric charge collecting on an object or on a surface of an object. In daily life, when two different objects touch with each other, one object loses some electric charges, such as electrons transferred to the other object, to be positively charged, while the other object receives some residual electrons to be negatively charged. If the electric charges are difficult to be neutralized during the separating process, the electric charges may be accumulated and the object is caused to be charged with static electricity. Friction is a process of constant contacting and separating between one surface and another surface. Frictional electrification is a process of unbalance between the positive and negative electric charges caused by contacting and separating. Therefore, frictional electrification is essentially contacting and separating electrification. In daily life, all kinds of objects may generate static electricity due to movement or friction.

Currently, due to the benefits of compact size, portability and convenience in use, the mainstream hand-held wireless vacuum cleaners on the market are widely used by users. During the working process, fine particles, such as dust and flour on the ground, may rub against the entire inner wall of the air duct as being sucked, and a large amount of electrons may be accumulated to generate static electricity. That is commonly known as frictional electrification, and the phenomenon may be especially obvious when the weather is dry.

Static electricity may be collected on the surface of the conductor, such as an aluminum tube, to a certain peak. When human hands contacting with the aluminum tube, the static electricity accumulated on the aluminum tube may be released from the human body, causing electrostatic shock, e.g. on the human's hand, and resulting in discomfort to the user. When the electrostatic voltage is large, it may be harmful to the human body, which greatly affects the user experience of the product. At the same time, a large accumulation of static electricity is very likely to damage or even break down important components near the strong electrostatic fields, such as circuit boards. That is, static electricity not only affects the service life of the machine, but also is a safety hazard.

In view of the above problems, it is necessary to design an electrostatic protection system to prevent the hand-held wireless vacuum cleaner from generating static electricity during working process, which causes discomfort to the human body, to protect important components of the machine, such as the circuit board, from electrostatic damage, and to extend the service life of the machine.

### SUMMARY

In view of the above, an object of the present application is to provide an electrostatic protection system and a hand-held vacuum cleaner using the same, which can protect the important components inside the machine from electrostatic damage and avoid electrostatic shock, e.g. on the human's hand, by effectively transferring the accumulated electrostatic charges.

In order to achieve the above object, the technical solutions of the present invention are as follows.

An electrostatic protection system for a hand-held wireless vacuum cleaner, comprises an electrostatic collecting unit and an electrostatic dissipating unit; the electrostatic collecting unit comprises an electrostatic collecting device; the electrostatic dissipating unit comprises a battery pack assembly, and the electrostatic collecting device is electrically connected to a negative electrode of the battery pack assembly; the electrostatic collecting unit is electrically connected to the electrostatic dissipating unit, and an electrostatic charge is transmitted to the negative electrode of the battery pack assembly through the electrostatic collecting device to realize electrostatic charge transfer.

Preferably, the electrostatic dissipating unit comprises an electrostatic adapter plate connected to the electrostatic collecting unit, and the electrostatic adapter plate is electrically connected to the negative electrode of the battery pack assembly.

Preferably, the electrostatic adapter plate is used to collect the electrostatic charge and transfer the electrostatic charge to the negative electrode of the battery pack assembly.

Preferably, the electrostatic adapter plate comprises at least one resistor and at least one capacitor connected in parallel with the resistor.

Preferably, the electrostatic adapter plate comprises several resistors connected in series and several capacitors connected in parallel with each of the several resistors.

Preferably, the hand-held wireless vacuum cleaner is provided with a dust suction pipe, and the electrostatic collecting device is disposed in contact with the dust suction pipe.

Preferably, the electrostatic dissipating unit further comprises an electrostatic lead electrically connected between the electrostatic collecting device and the electrostatic adapter plate.

Preferably, the electrostatic collecting device further comprises an electrostatic metal insert and an electrostatic metal wire; one end of the electrostatic metal insert is disposed in the dust suction pipe and is in contact with the wall of the dust suction pipe; one end of the electrostatic metal wire is in contact with the electrostatic metal insert, and the other end extends to the outside of the dust suction pipe and is connected to the electrostatic lead.

Preferably, the battery pack assembly comprises a battery assembly and a circuit board assembly; and the electrostatic adapter plate is connected to the negative electrode of the circuit board assembly by a lead.

Preferably, the battery pack assembly comprises a battery assembly and a circuit board assembly; and the electrostatic adapter plate is connected to the negative electrode of the battery assembly by a lead.

Preferably, the hand-held wireless vacuum cleaner further comprises a main motor, and the electrostatic charge generated by the main motor is transferred to the negative electrode of the battery pack assembly.

Preferably, the hand-held wireless vacuum cleaner further comprises a main motor, and the electrostatic charge generated by the main motor is connected to an electrostatic charge input end of the electrostatic adapter plate.

Preferably, the hand-held wireless vacuum cleaner comprises a main motor circuit board, and the main motor circuit board is provided with a transient voltage suppressor with a protection function.

A hand-held wireless vacuum cleaner comprises any of the above-mentioned electrostatic protection systems.

An electrostatic protection system comprises an electrostatic collecting unit and an electrostatic dissipating unit; the electrostatic collecting unit is used to collect static electricity and centrally transmit static electricity; the electrostatic dissipating unit comprises an electrostatic adapter plate and a battery pack assembly; the electrostatic collecting unit is electrically connected to the electrostatic adapter plate of the electrostatic dissipating unit, and the battery pack assembly is provided with a circuit board assembly and a battery assembly electrically connected to the circuit board assembly; and the electrostatic adapter plate is optionally electrically connected to a negative electrode of the battery assembly or a negative electrode of the circuit board assembly.

Preferably, the electrostatic adapter plate is used to collect an electrostatic charge and transfer the electrostatic charge to the negative electrode of the battery pack assembly.

Preferably, the electrostatic adapter plate comprises at least one resistor and at least one capacitor connected in parallel with the resistor.

Preferably, the electrostatic adapter plate comprises several resistors connected in series and several capacitors connected in parallel with each of the several resistors.

Compared with the related art, in the present invention, the electrostatic charges accumulated in the dust suction pipe and the main motor of the vacuum cleaner are conducted to a negative electrode of a battery to perform electrostatic charge transfer, thereby avoiding the phenomenon of electrostatic shock, e.g. on the human's hand, caused by the static electricity generated during working process of the vacuum cleaner. The user experience of the product is improved.

### BRIEF DESCRIPTION OF THE DRAWINGS

In order to more clearly illustrate the embodiments of the present invention and the technique solutions in the related art, the drawings used in descriptions of the embodiments and the related art will be briefly described below. Obviously, the drawings in the following description are only some of the embodiments of the present invention, and those skilled in the art can obtain other drawings based on these drawings without any creative work.

FIG. 1 is a schematic diagram of an electrostatic protection system for a hand-held wireless vacuum cleaner in accordance with an embodiment of the present invention;

FIG. 2 is a perspective view of a hand-held wireless vacuum cleaner using the electrostatic protection system in FIG. 1 in accordance with an embodiment of the present invention;

FIG. 3 is an exploded view of hand-held wireless vacuum cleaner using the electrostatic protection system in FIG. 1 in accordance with an embodiment of the present invention.

### REFERENCE NUMERALS AND COMPONENTS INVOLVED IN THE DRAWINGS

1, dust suction pipe; 2, electrostatic metal insert; 3, electrostatic metal wire; 4, electrostatic lead; 5, electrostatic adapter plate; 6, battery pack assembly; 7, the main motor circuit board.

### DETAILED DESCRIPTION OF EMBODIMENTS

Currently, during the working process of a hand-held wireless vacuum cleaner, fine particles, such as dust and flour on the ground, may rub against the entire inner wall of the air duct as being sucked, and a large amount of electrons may be accumulated to generate static electricity. The static electricity may be collected on the surface of the conductor (e.g. metal tubes, such as an aluminum tube), to a certain peak. When human hands contacting with the conductor, a large amount of electrons may be transferred and the static electricity accumulated on the conductor may be released from the human body, causing electrostatic shock, e.g. on the human's hand, and resulting in discomfort to the user. When the electrostatic voltage is large, it may be harmful to the human body, which greatly affects the user experience of the product. At the same time, a large accumulation of static electricity is very likely to damage or even break down important components near the strong electrostatic fields, such as circuit boards. That is, static electricity not only affects the service life of the machine, but also is a safety hazard.

In practical life, when the static electricity is generated by an object, the generated static electricity is usually conducted into the ground through various methods, i.e., ground connection. In this way, the generated static electricity is dissipated through the ground, and a large accumulation of static electricity would not be generated, thus avoiding the phenomenon of electrostatic shock, e.g. on the human's hand, when the human body touching the object.

However, in the actual product design process, it is usually very difficult to achieve electrostatic ground connection or the ground connection process is complicated. Especially for a wireless product, the product structure for ground connection is to be more complicated. In order to overcome the difficulty of electrostatic ground connection for a wireless product, the present invention provides a new-type electrostatic protection system.

In view of the above problems, since the wireless product does not have a power lead connected to the power source, there is no way to conduct the static electricity to the ground. The present invention provides an electrostatic protection system, and more particularly an electrostatic protection system for a hand-held wireless vacuum cleaner. The electrostatic protection system not only can prevent the hand-held wireless vacuum cleaner from generating static electricity during working process, which causes discomfort to the human body, but also can protect important components of the machine, such as the circuit board, from electrostatic damage and extend the service life of the machine.

The technical solutions of the present invention will be clearly and completely described by way of specific embodiments below. It is apparent that the described embodiments are only some of the embodiments of the invention, and are not all of the embodiments. All other embodiments obtained by those skilled in the art based on the embodiments of the present invention without creative efforts are within the protection scope of the present invention.

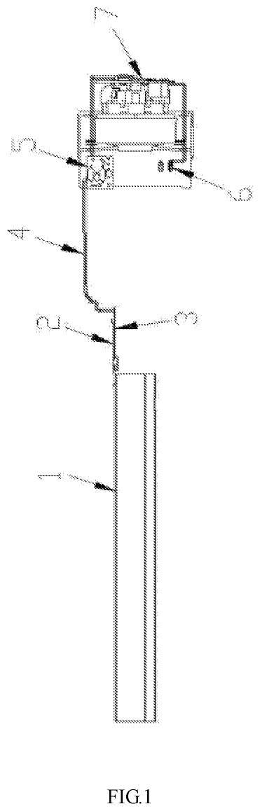

Referring to FIG. 1, an electrostatic protection system for a hand-held wireless vacuum cleaner comprises an electrostatic collecting unit and an electrostatic dissipating unit.

The electrostatic collecting unit comprises an electrostatic collecting device. A hand-held wireless vacuum cleaner is provided with a lengthwise dust suction pipe 1 made of metal material. For example, the metal material comprise, but is not limited to, aluminum, or iron. The electrostatic collecting device is disposed in contact with the dust suction pipe. The electrostatic collecting device comprises an electrostatic metal insert 2 and an electrostatic metal wire 3. The electrostatic metal insert 2 is disposed at one end of the dust suction pipe 1 and in contact with the wall of the dust suction pipe 1. One end of the electrostatic metal wire 3 is contacted with the electrostatic metal insert 2, the other end of the electrostatic metal wire 3 extends to the outside of the dust suction pipe 1 and connected to an electrostatic lead 4. The electrostatic metal insert 2 and the electrostatic metal wire 3 can be integrally provided by one component, or may be provided by the connection of two or more components connected with each other, as shown in the present embodiment.

The electrostatic dissipating unit comprises an electrostatic lead 4, an electrostatic adapter plate 5 and a battery pack assembly 6. The electrostatic lead 4 is electrically connected between the electrostatic collecting device and the electrostatic adapter plate 5. The output end of the electrostatic adapter plate 5 is electrically connected to the negative electrode of the battery pack assembly 6. The battery pack assembly 6 comprises a battery assembly and a circuit board assembly, and the electrostatic adapter plate 5 is connected to the negative electrode of the battery assembly.

The electrostatic collecting unit and the electrostatic dissipating unit are electrically connected with each other by an electrostatic lead 4, and the generated static electricity is sequentially passed through the dust suction pipe 1, the electrostatic metal insert 2, the electrostatic metal wire 3, the electrostatic lead 4, the electrostatic adapter plate 5 and passed to the negative electrode of the battery assembly, achieving electrostatic charge transfer.

The hand-held wireless vacuum cleaner further comprises a main motor and a main motor circuit board electrically connected to the main motor. The main motor circuit board is provided with a transient voltage suppressor (TVS) with a protection function, to prevent the main motor circuit board from damage caused by short circuit or excessive current of the main motor circuit board.

The main motor comprises a metal shell. During the working process of the main motor, static electricity is generated due to the rotation of the impeller of the main motor and the friction between the dust and the shell. A contact lead is disposed on the metal shell for dissipating the static electricity from the shell.

In one embodiment of the present invention, the contact lead arranged on the metal shell is connected to the electrostatic lead 4 and further electrically connected to the electrostatic adapter plate 5. The static electricity generated by the dust suction pipe and the static electricity generated by the main motor pass through the electrostatic adapter plate 5 after flowing together and then flow to the negative electrode of the battery assembly.

In another embodiment of the present invention, the contact lead arranged on the metal shell is connected to an output end of the electrostatic adapter plate and then directly connected to the negative electrode of the battery assembly.

The electrostatic adapter plate comprises several resistors connected in series, each of which has one capacitor connected in parallel therewith. The number of the resistors is no less than one. In other embodiments, the electrostatic adapter plate can also comprise several capacitors connected in series in parallel with several resistors connected in series. The resistance values of the resistors on the electrostatic adapter plate is selected as appropriate according to the number of resistors connected in series.

In the present invention, the capacitor arranged on the electrostatic adapter plate can be used to collect a part of the electric charges, and at the same time, when the electric charges pass through the electrostatic adapter plate, the electric charges move slowly due to the setting of the resistors. The circuit board inside the vacuum cleaner is prevented from damage caused by excessive or overquick charges, and the other components are prevented from being broken down.

The working principle of the electrostatic protection system is as follows.

During the working process of the vacuum cleaner, the dust in the dust suction pipe 1 rubs with each other and against the wall of the dust suction pipe, thereby generating a large accumulation of electric charges, and generating static electricity. The electric charges are accumulated on the surface of dust suction pipe 1. The electrostatic metal insert 2 inside the dust suction pipe 1 guides the electrostatic charges accumulated on the surface of the dust suction pipe 1 to the electrostatic lead 4 of the electrostatic dissipating unit through the electrostatic metal wire 3 connected to the electrostatic metal insert 2. The electrostatic charges are led to the electrostatic adapter plate 5 through the electrostatic lead 4, and the electrostatic charges do not flow too fast through the electrostatic adapter plate 5, but a large amount of electrostatic charges are accumulated in the electrostatic adapter plate 5, due to property of the high resistance of the electrostatic adapter plate 5 itself. The electric charges flow to the negative electrode of the battery pack assembly through the electrostatic adapter plate 5. Especially after the user stops using the hand-held vacuum cleaner, the electric charges gradually flow toward to the negative electrode of the battery pack assembly. The static electricity generated by the main motor can be conducted to the electrostatic lead 4 and then conducted to the electrostatic adapter plate 5 to be converged, and finally flow into the negative electrode of the battery pack assembly 6. The static electricity generated by the main motor can also be directly conducted to the negative electrode of the battery pack assembly, In this way, electrostatic charge transfer is achieved.

In a preferred embodiment, a large accumulation of electrostatic charges on the electrostatic adapter plate 5 and the electrostatic charges generated by the main motor are converged together and then directly conducted to the negative electrode of the battery assembly of the battery pack assembly 6.

In the embodiment of the present invention, points are randomly selected on the dust suction pipe of the hand-held wireless vacuum cleaner. 10 points are randomly selected for testing in the experiment. When the dust suction pipe is connected and disconnected with the electrostatic collecting unit, changes of the electrostatic values at the points of the dust suction pipe are shown in the following table (unit: kV):

| NO. | 1 | 2 | 3 | 4 | 5 | 6 | 7 | 8 | 9 | 10 |
|---|---|---|---|---|---|---|---|---|---|---|
| A static | 48.1 | 39.3 | 67.2 | 66 | 45.1 | 52.7 | 60.8 | 66.0 | 59.0 | 53.2 |
| voltage | | | | | | | | | | |
| B static | 33.3 | 27.8 | 15.2 | 12.4 | 18.2 | 13.1 | 19.8 | 20.0 | 16.2 | 18.6 |
| voltage | | | | | | | | | | |

In the test table, A represents the static voltage on the dust suction pipe when the dust suction pipe is disconnected from the electrostatic collecting unit, and B represents the static voltage on the dust suction pipe when the dust suction pipe is connected to the electrostatic collecting unit.

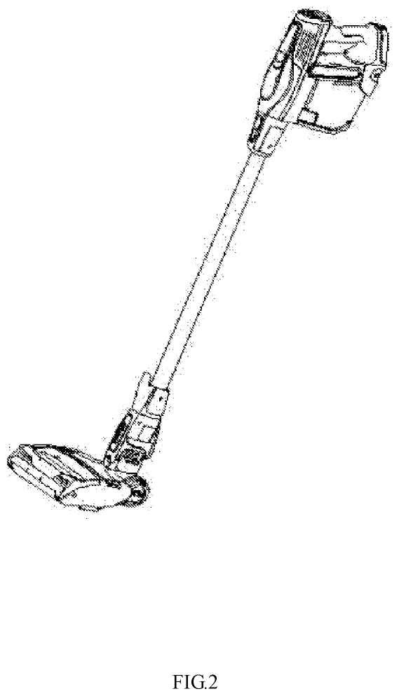

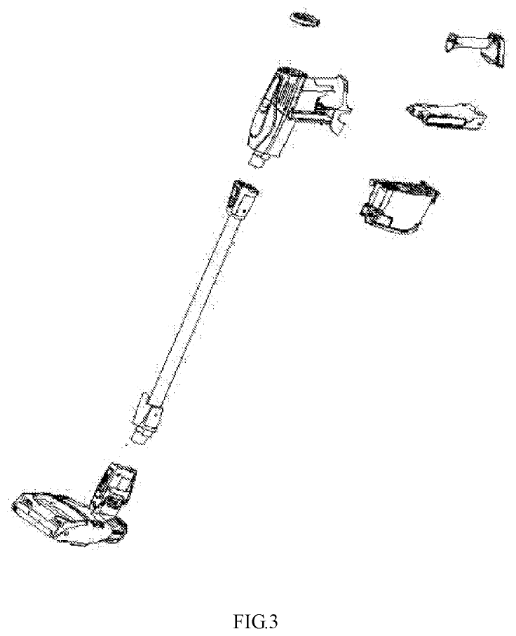

Referring to FIG. 2 to FIG. 3, the present invention further provides a hand-held wireless vacuum cleaner comprising the above-mentioned electrostatic protection system. The entire electrostatic protection system is mounted in the body of the vacuum cleaner. The static electricity can be slowly conducted into the electrostatic dissipating unit inside the vacuum cleaner from the dust suction pipe of the vacuum cleaner, collected in the electrostatic dissipating unit, and then be converged with the static electricity generated by the main motor to flow into the negative electrode of the battery pack assembly together. In this way, the electrostatic charge transfer of the entire vacuum cleaner can be achieved, avoiding the phenomenon of electrostatic shock, e.g. on the human's hand, when using the hand-held wireless vacuum cleaner.

Generally, the floor brush parts of the hand-held vacuum cleaner also have dust rubbing therein. Most of the floor brushes are made of plastic material. In the design, it is easy to ignore the static electricity of the floor brush parts. In the present electrostatic protection system, the dust suction pipe is directly connected to the floor brush, and the electrostatic charges generated by the floor brush moves along the direction of the metal dust suction pipe, thereby increasing the quantity of electric charges of static electricity. In an embodiment of the present invention, a metal conductive piece (not shown) can be used to transmit the static electricity of the floor brush to the dust suction pipe. Finally, the static electricity is conducted to the negative electrode of the battery pack assembly through the above-mentioned structure.

Further, the present invention also provides an electrostatic protection system comprising an electrostatic collecting unit and an electrostatic dissipating unit. The electrostatic collecting unit is used to collect static electricity and centrally transmit static electricity. The electrostatic dissipating unit comprises an electrostatic adapter plate and a battery pack assembly. The electrostatic adapter plate is electrically connected to the negative electrode of the battery pack assembly, and the electrostatic collecting unit is electrically connected to the electrostatic adapter plate of the electrostatic dissipating unit. The battery pack assembly is provided with a circuit board assembly, and the electrostatic adapter plate and the circuit board assembly of the battery pack assembly are disposed on the same circuit board. The application of the electrostatic protection system is not limited to hand-held vacuum cleaners and is not limited to dust suction pipes. The electrostatic protection system can be used in any suitable situation where the electrostatic dissipating is required.

In summary, in the present invention, for the first time, the static charges accumulated on the floor brush, the dust suction pipe and the main motor of the vacuum cleaner are conducted to the negative electrode of the battery assembly through the metal conductor, to realize electrostatic charge transfer, avoiding the phenomenon of electrostatic shock on the human body, e.g. on the human's hand, caused by the static electricity generated during the working process of vacuum cleaner.

The above description of the disclosed embodiments enables those skilled in the art to practice or use the invention. Various modifications to these embodiments are obvious to those skilled in the art, and the general principles defined herein may be implemented in other embodiments without departing from the spirit or scope of the invention. Accordingly, the invention should not be limited to the specific embodiments described herein, but should be accorded the broadest scope consistent with the principles and novel features disclosed herein.

What is claimed is:

1. An electrostatic protection system for a hand-held wireless vacuum cleaner, comprising an electrostatic collecting unit and an electrostatic dissipating unit; said electrostatic collecting unit comprises an electrostatic collecting device; said electrostatic dissipating unit comprises a battery pack assembly, wherein said electrostatic collecting device is electrically connected to a negative electrode of said battery pack assembly; wherein said electrostatic collecting unit is electrically connected to the electrostatic dissipating unit, and an electrostatic charge is transmitted to the negative electrode of the battery pack assembly through said electrostatic collecting device to realize electrostatic charge transfer.

2. The electrostatic protection system for a hand-held wireless vacuum cleaner as claimed in claim 1, wherein said electrostatic dissipating unit comprises an electrostatic adapter plate connected to said electrostatic collecting unit, and said electrostatic adapter plate is electrically connected to the negative electrode of said battery pack assembly.

3. The electrostatic protection system for a hand-held wireless vacuum cleaner as claimed in claim 2, wherein said electrostatic adapter plate is used to collect the electrostatic charge and transfer the electrostatic charge to the negative electrode of said battery pack assembly.

4. The electrostatic protection system for a hand-held wireless vacuum cleaner as claimed in claim 2, wherein said electrostatic adapter plate comprises at least one resistor and at least one capacitor connected in parallel with said resistor.

5. The electrostatic protection system for a hand-held wireless vacuum cleaner as claimed in claim 2, wherein said electrostatic adapter plate comprises several resistors connected in series and several capacitors connected in parallel with each of said several resistors.

6. The electrostatic protection system for a hand-held wireless vacuum cleaner as claimed in claim 2, wherein said hand-held wireless vacuum cleaner is provided with a dust suction pipe, and said electrostatic collecting device is disposed in contact with said dust suction pipe.

7. The electrostatic protection system for a hand-held wireless vacuum cleaner as claimed in claim 6, wherein said electrostatic dissipating unit further comprises an electrostatic lead electrically connected between said electrostatic collecting device and said electrostatic adapter plate.

8. The electrostatic protection system for a hand-held wireless vacuum cleaner as claimed in claim 7, wherein said electrostatic collecting device further comprises an electrostatic metal insert and an electrostatic metal wire; wherein one end of said electrostatic metal insert is disposed in said dust suction pipe and is in contact with the wall of said dust suction pipe; and wherein one end of said electrostatic metal wire is in contact with said electrostatic metal insert, and the other end extends to the outside of said dust suction pipe and is connected to said electrostatic lead.

9. The electrostatic protection system for a hand-held wireless vacuum cleaner as claimed in claim 2, wherein said battery pack assembly comprises a battery assembly and a circuit board assembly; and wherein said electrostatic adapter plate is connected to the negative electrode of said circuit board assembly by a lead.

10. The electrostatic protection system for a hand-held wireless vacuum cleaner as claimed in claim 2, wherein said battery pack assembly comprises a battery assembly and a circuit board assembly; and wherein said electrostatic adapter plate is connected to the negative electrode of said battery assembly by a lead.

11. The electrostatic protection system for a hand-held wireless vacuum cleaner as claimed in claim 9, wherein said hand-held wireless vacuum cleaner further comprises a main motor, and the electrostatic charge generated by said main motor is transferred to the negative electrode of said battery pack assembly.

12. The electrostatic protection system for a hand-held wireless vacuum cleaner as claimed in claim 1, wherein said hand-held wireless vacuum cleaner further comprises a main motor, and the electrostatic charge generated by said main motor is connected to an electrostatic charge input end of said electrostatic adapter plate.

13. The electrostatic protection system for a hand-held wireless vacuum cleaner as claimed in claim 10, wherein said hand-held wireless vacuum cleaner comprises a main motor circuit board, and said main motor circuit board is provided with a transient voltage suppressor with a protection function.

14. A hand-held wireless vacuum cleaner, comprising the electrostatic protection system for a hand-held wireless vacuum cleaner as claimed in 1.

15. An electrostatic protection system, comprising an electrostatic collecting unit and an electrostatic dissipating unit; wherein said electrostatic collecting unit is used to collect static electricity and centrally transmit static electricity; wherein said electrostatic dissipating unit comprises an electrostatic adapter plate and a battery pack assembly; wherein the electrostatic collecting unit is electrically connected to said electrostatic adapter plate of said electrostatic dissipating unit, wherein said battery pack assembly is provided with a circuit board assembly and a battery assembly electrically connected to said circuit board assembly; and wherein said electrostatic adapter plate is optionally electrically connected to a negative electrode of said battery assembly or a negative electrode of said circuit board assembly.

16. The electrostatic protection system as claimed in claim 15, wherein said adapter plate is used to collect an electrostatic charge and transfer the electrostatic charge to the negative electrode of said battery pack assembly.

17. The electrostatic protection system as claimed in claim 15, wherein said electrostatic adapter plate comprises at least one resistor and at least one capacitor connected in parallel with said resistor.

18. The electrostatic protection system as claimed in claim 15, wherein said electrostatic adapter plate comprises several resistors connected in series and several capacitors connected in parallel with each of said several resistors.
